(19) United States
(12) Patent Application Publication
(10) Pub. No.: US 2016/0244007 A1
(43) Pub. Date: Aug. 25, 2016

(54) METHOD AND APPARATUS FOR MONITORING A QUIESCENT STATE IN A MOTOR VEHICLE

(71) Applicant: Dr. Ing. h.c. F. Porsche Aktiengesellschaft, Stuttgart (DE)

(72) Inventor: Daniel Spesser, Illingen (DE)

(21) Appl. No.: 15/018,982

(22) Filed: Feb. 9, 2016

(30) Foreign Application Priority Data
Feb. 19, 2015 (DE) 10 2015 102 352.0

(51) Int. Cl. B60R 16/03; B60L 11/18

(52) U.S. Cl. CPC B60R 16/03; B60L 11/1809

(57) ABSTRACT

A method is provided for monitoring a quiescent state in a motor vehicle. In accordance with the method, a wake-up controller (10) of a control device selects at least one peripheral component from among a plurality of peripheral components of the motor vehicle. The peripheral components are connected to the control device in an event-controlled manner in the quiescent state. The wake-up controller (10) checks an operating state of the selected peripheral component and wakes up the motor vehicle from the quiescent state depending on the operating state.

### CROSS REFERENCE TO RELATED APPLICATION

This application claims priority under 35 USC 119 to German Patent Appl. No. 10 2015 102 352.0 filed on Feb. 199, 2015, the entire disclosure of which is incorporated herein by reference.

### BACKGROUND

1. Field of the Invention

The invention relates to a method for monitoring a quiescent state in a motor vehicle. The present invention further relates to a corresponding apparatus in the form of a wake-up controller, to a corresponding computer program and to a corresponding storage medium.

2. Description of the Related Art

Various approaches for supplying a quiescent current to a control device in a motor vehicle can be found in the prior art. Some known control devices of this kind have a plurality of peripheral components. An example is an on-board charger (OBC) for connecting the traction battery of an electrically driven motor vehicle to the stationary power supply grid by means of a charging cable. Peripheral components of this kind can function to control or read back information. In the case of an on-board charger, the peripheral components may comprise plug connectors, pushbuttons or light-emitting diodes that have corresponding diagnosis resistors for forming information and for checking plausibility and for diagnosis purposes. Additionally, a “sleeping” motor vehicle is awaken by a wake-up controller and corresponding actions by a user. The user action may be the connection of a plug to the provided charging socket or pushing a pushbutton in the case of the on-board charger. Therefore, current has to be applied to all of the diagnosis resistors, and the read-back voltage has to be processed as an information carrier to decide whether the motor vehicle should be awaken. This results in a sharp increase in the quiescent current.

U.S. Pat. No. 6,198,995 proposes a method for operating a vehicle monitoring system that has inputs of a large number of vehicle subsystems. The vehicle is switched to a standby mode where normally no commissioning signals are applied to the inputs by the large number of vehicle subsystems. The inputs then are scanned for commissioning signals in recurring cycles. This scanning process is adjusted in terms of time over a predetermined time period. The time between the cycles from one scanning step to another is extended in response to a lack of commissioning signals at least at certain inputs in each predetermined time period for each preceding scanning step.

U.S. Pat. No. 6,674,762 states that, in an electronic system for transmitting data between a number of stations, partial system operation is possible by suitable selection of signal levels and wake-up levels, so that some of the stations can communicate with one another, while other stations are in a quiescent mode and save power.

EP 0 571 718 B1 discloses a circuit for standby operation of a functional group in a vehicle. The functional group is formed from a control device, sensors and actuators. The circuit supplies voltage to the functional group and to keep certain ranges of functions activated and/or to activate certain ranges of functions and to block other ranges of functions when the vehicle is turned off and standby operation is activated. Automatic deactivation of standby operation is provided after a predefined time or given predefined sensor values that indicate, for example, depletion of the energy supply.

U.S. Pat. No. 7,183,896 B2 and KR 10-1131526 relate to further relevant methods, apparatuses, control systems and media.

### SUMMARY

The invention provides a method for monitoring a quiescent state in a motor vehicle, a corresponding apparatus, a corresponding computer program and a corresponding storage medium.

Adaptive control is provided by the wake-up controller in the control device by having the wake-up controller select a peripheral component in a selective and event-controlled manner and checking only individual peripheral components.

The quiescent current can be reduced significantly by automatically identifying and selecting the peripheral components of the control device using the wake-up controller.

This solution provides particular advantages when an on-board charger of the generic type is used. For example, if no plug is plugged into the charging socket, no peripheral component is checked; if a charging plug is plugged into the charging socket but there is no control signal/CP signal, only one peripheral component is checked.

An exemplary embodiment of the invention is illustrated in the drawings and will be described in greater detail in the text that follows.

### BRIEF DESCRIPTION OF THE DRAWINGS

FIG. 1 shows an electronic circuit diagram of a wake-up controller according to the invention.

FIG. 2 shows a block diagram of a method according to the invention.

FIG. 3 illustrates the timing sequence for the application of current to individual wake-up outputs.

### DETAILED DESCRIPTION

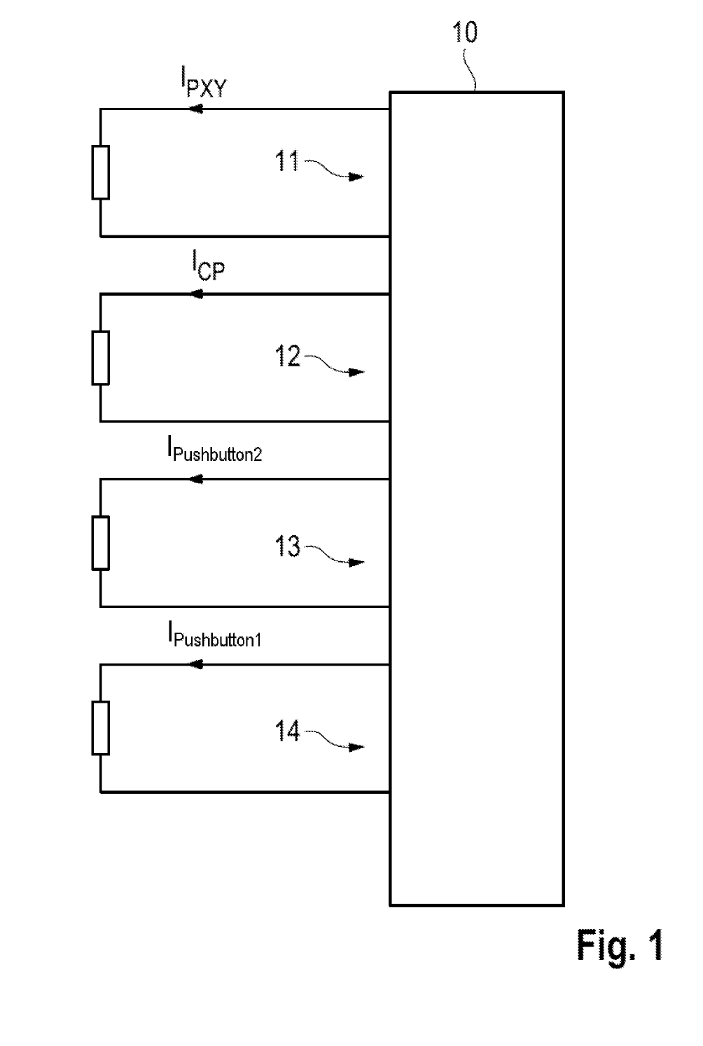

FIG. 1 shows a wake-up controller 10 according to the invention for a control device for monitoring a quiescent state in a motor vehicle. In the present case, the control device is an on-board charger (OBC) having—cited as shown from top to bottom in the figure—a first wake-up output 11, a second wake-up output 12, a third wake-up output 13 and a fourth wake-up output 14, which wake-up outputs are respectively associated with a plug, a pilot contact, a second pushbutton and a first pushbutton. It goes without saying that an extremely wide variety of further peripheral components of the motor vehicle—not illustrated in its entirety for reasons of simplicity—can be connected to the on-board charger without departing from the scope of the invention.

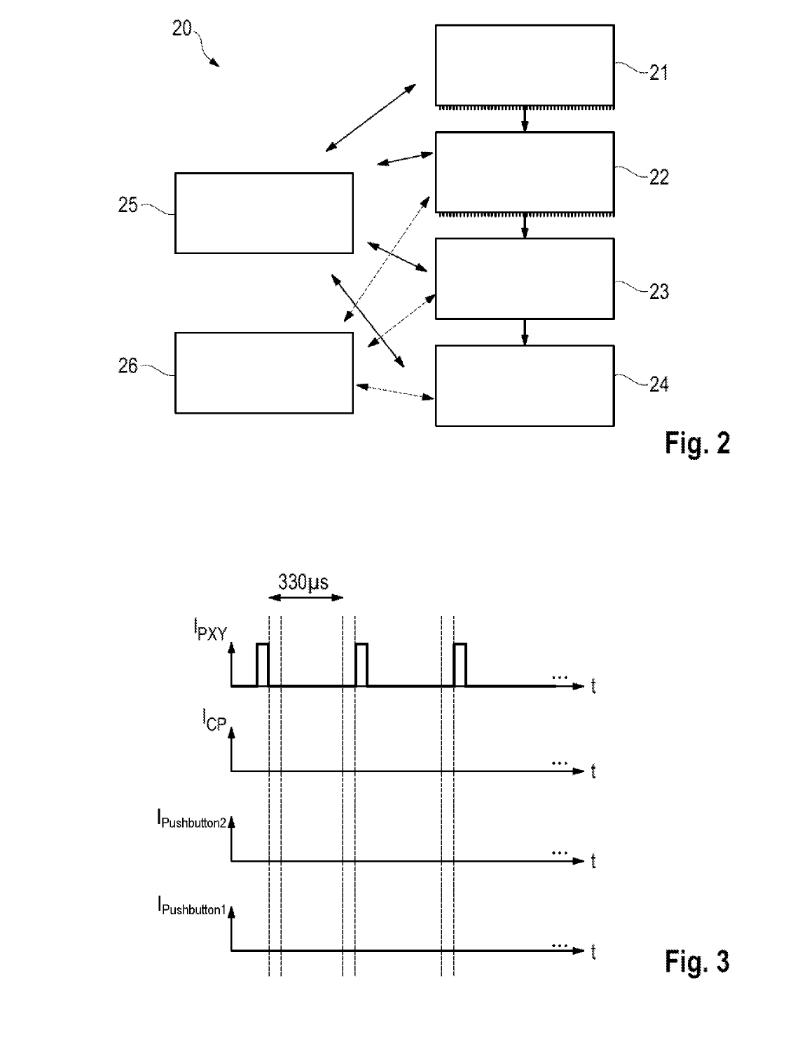

The wake-up controller 10 may check each of the peripheral components cited by way of example by means of a specific quiescent current I_{PXY}, I_{CP}, I_{Pushbutton 2} or I_{Pushbutton1} which, for this purpose, flows through a diagnosis resistor of the respective peripheral component. The wake-up operation according to the invention for the motor vehicle can therefore be performed depending on a read-back voltage which is dropped across the diagnosis resistor and indicates the operating state of the respective peripheral component. FIG. 2 illustrates details of this procedure.

To this end, the wake-up controller 10 of the on-board charger according to FIG. 1 selects at least one peripheral component from among the peripheral components in an event-controlled manner, said wake-up controller checking the operating state of said at least one peripheral component in the manner described above. In this case, said peripheral component is selected by a first module of the wake-up controller 10, before a second module of the wake-up controller 10 selects the corresponding wake-up outputs. In the meantime, a third module 25 of the wake-up controller 10 collects historical information for a diagnosis, while a fourth module 26 of the wake-up controller 10 monitors and checks the plausibility of connection operations of the wake-up outputs 11, 12, 13, 14. Finally, a fifth module of the wake-up controller 10 continues to monitor idling of the on-board charger as required. The included modules of the invention can be cascaded in any desired manner in this case and are only examples.

The functional interaction between the individual modules can take place as follows: a first operating situation 21 of the on-board charger is present as long as the fifth module determines that no plug is plugged in. In this first operating situation 21, all of the wake-up outputs 11, 12, 13, 14 are blocked and a check is no longer made, wherein only the first wake-up output 11 forms an exception. In this first operating situation 21, the quiescent current is reduced to one tenth in comparison to conventional methods.

In a second operating situation 22 of the on-board charger, the plug is plugged in and the first module is active. In this second operating situation 22, only the quiescent current I_{PXY} is currently flowing through the first wake-up output 11.

The same is not true in a third operating situation 23 in which not only is the plug plugged in, but the CP signal is applied to the pilot contact of said plug. In this case, the second module is active. In this third operating situation 23, the respective quiescent currents I_{PXY}, I_{CP}, I_{Pushbutton2} and, respectively, I_{Pushbutton1} flow through the first wake-up output 11, the second wake-up output 12, the third wake-up output 13 and the fourth wake-up output 14 and said wake-up outputs are checked, so that the greatest possible total quiescent current I_{PXY}+I_{CP}+I_{Pushbutton2}+I_{Pushbutton1} is produced.

Finally, in a fourth operating situation 24 of the on-board charger, the plug is plugged in, the CP signal is dispensed with and the second module is active, while the first module changes the mode. Thus, only the quiescent current I_{PXY} flows through the first wake-up output 11 and only the quiescent current I_{CP} flows through the second wake-up output 12, while the third and fourth wake-up outputs 13 and 14 are deactivated, this leading to a considerable reduction in the consumption of quiescent current.

The benefit of the approach according to the invention can be seen in the wake-up application of current illustrated for the second operating situation 22 in FIG. 3 in which only the plug is plugged in. In this operating situation, the first module checks the plug over time t in such a way that the quiescent current I_{PXY} flows through the diagnosis resistor of the plug connection periodically at a time interval corresponding to the average operating duration of a pushbutton by a user, for example of approximately 330 μs, whereas current is not applied to the other wake-up outputs 12, 13, 14. Therefore, by way of example, the following average quiescent current is produced overall:

I_{PXY}+I_{CP}+I_{Pushbutton2}+I_{Pushbutton1}=100 μA

What is claimed is:

1. A method for monitoring a quiescent state in a motor vehicle using a control device, the method using a wake-up controller of the control device to perform the following steps:
selecting at least one peripheral component from among a plurality of peripheral components of the motor vehicle, the peripheral components being connected to the control device, in an event-controlled manner in the quiescent state,
the wake-up controller checking an operating state of the selected peripheral component, and
waking up the motor vehicle from the quiescent state depending on the operating state.

2. The method of claim 1, wherein the control device is an on-board charger.

3. The method of claim 2, further comprising:
checking a plug by means of a first wake-up output of the on-board charger,
checking a pilot by means of a second wake-up output of the on-board charger,
checking a second pushbutton by means of a third wake-up output of the on-board charger, and
checking a first pushbutton by means of a fourth wake-up output of the on-board charger.

4. The method of claim 3, further comprising:
using a first module of the wake-up controller to check the operating state,
using a second module of the wake-up controller to select the wake-up outputs,
using a third module of the wake-up controller to collect historical information for a diagnosis,
using a fourth module of the wake-up controller to monitor and check a plausibility of connection operations of the wake-up outputs, and
using a fifth module of the wake-up controller to continue to monitor idling of the on-board charger.

5. The method of claim 4, further comprising:
disconnecting the plug and activating the fifth module in a first operating situation of the on-board charger,
connecting the plug and activating the first module in a second operating situation of the on-board charger,
connecting the plug, applying a signal to the pilot contact and activating the second module in a third operating situation of the on-board charger, and
connecting the plug, dispensing with the signal and activating the second module and the first module in a fourth operating situation of the on-board charger.

6. The method of claim 5, wherein:
the checking operation is performed by a quiescent current that flows through a diagnosis resistor of the peripheral component, and
the wake-up operation is performed depending on a read-back voltage that is dropped across the diagnosis resistor.

7. The method of claim 6, further comprising, operating the first module in the second operating situation to check the plug so as to determine whether the quiescent current is flowing through the diagnosis resistor periodically with a time interval of approximately 330 μs.

8. A wake-up controller for a control device for monitoring a quiescent state in a motor vehicle, comprising:
means for selecting at least one peripheral component from among a plurality of peripheral components of the motor vehicle, the peripheral components are connected to the control device, in an event-controlled manner,
means for checking an operating state of the selected peripheral component, and
means for waking up the motor vehicle depending on the operating state.

9. A computer program that is designed to carry out all of the steps of the method of claim 1.

10. A machine-readable storage medium with the computer program of claim 9 stored in the machine-readable storage medium.
